(19) United States
(12) Patent Application Publication
(10) Pub. No.: US 2006/0198275 A1
(43) Pub. Date: Sep. 7, 2006

(54) Apparatus and method for reproduction of holograms

(76) Inventor: Kazuya Kogure, Gunma (JP)

Correspondence Address: FISH & RICHARDSON P.C., P.O. BOX 1022, MINNEAPOLIS, MN, 55440-1022, US

(21) Appl. No.: 11/262,973

(22) Filed: Nov. 1, 2005

(30) Foreign Application Priority Data
Mar. 4, 2005 (JP) 2005-060892

(51) Int. Cl. G11B 7/00

(52) U.S. Cl. 369/103

(57) ABSTRACT

A hologram reproduction apparatus comprises a first optical system disposed on one side of the hologram recording medium to form an optical path of the reproduction reference beam using the same optical path as that of the recording reference beam; a second optical system disposed on the data beam optical path on the other side of the hologram recording medium that is opposed to the one side to receive a diffracted light obtained by causing the reproduction reference beam to strike on the one side of the hologram recording medium from the one side of the hologram recording medium and load captured image data corresponding to the image data; and a control unit operable to carry out an inverse Fourier transform process on the captured image data loaded into the second optical system.

### CROSS-REFERENCE TO RELATED APPLICATIONS

The present application claims priority from Japanese Patent Application No. 2005-60892 filed on Mar. 4, 2005, which is herein incorporated by reference.

### BACKGROUND OF THE INVENTION

1. Field of the Invention

The present invention relates to an apparatus and a method for the reproduction of holograms.

2. Description of the Related Art

<Outline of Hologram Recording and Reproduction>

One of hologram recording media adapted to record digital data as holograms is a photosensitive resin (e.g., photopolymer) sealed between glass substrates. To record digital data on a hologram recording medium as a hologram, a coherent laser beam from a laser device is first split into two beams by a PBS (Polarization Beam Splitter). Then, one of such laser beams (hereinafter referred to as “reference beam”) and a laser beam (hereinafter referred to as “data beam”), i.e., the beam reflecting two-dimensional gray image pattern information as a result of the irradiation of the other such beam onto an SLM (Spatial Light Modulator) having digital data formed as a two-dimensional gray image pattern, are irradiated onto a hologram recording medium with a given angle. This allows the recording of the digital data onto the hologram recording medium.

More specifically, the photosensitive resin making up the hologram recording medium has a finite number of monomers. When the laser beam (hereinafter referred to as “laser beam”) made up of the reference and data beams is irradiated thereonto, the monomers change into polymers correspondingly with the energy determined by the light intensity of the laser beam and the irradiation time. As a result of the transformation of the monomers into polymers, an interference fringe, made up of polymers, is formed correspondingly with the laser beam energy. Therefore, as a result of the formation of such an interference fringe in the hologram recording medium, digital data is recorded as a hologram. Later, remaining monomers migrate (spread) to those locations that have consumed monomers. Further, as a result of the irradiation of the laser beam, such monomers change into polymers. It is to be noted that FIG. 8 schematically illustrates how monomers transform into polymers correspondingly with the laser beam energy in the hologram recording medium.

It is also to be noted that when a large amount of digital data is to be recorded on the hologram recording medium, the incidence angle of the reference beam onto the hologram recording medium is changed to form a number of holograms, in other words it is possible to conduct the so-called “angle-multiplexed recording.” For example, one hologram formed on the hologram recording medium is called a page, and a multiplexed hologram made up of a number of pages is called a book. FIG. 9 schematically illustrates the book and the pages in the angle-multiplexed recording. As shown in FIG. 9, the incidence angle of the reference beam is varied to form, for example, ten pages of holograms for a single book in the angle-multiplexed recording. Consequently, the angle-multiplexed recording allows the recording of a large amount of digital data.

Further, to reproduce digital data from the hologram recording medium, the reference beam is irradiated onto the interference fringe representing the digital data with the same incidence angle in which the interference fringe was formed. The reference beam (hereinafter referred to as “reproduction beam”) diffracted by the interference fringe is received by an image sensor or other means. The reproduction beam received by the image sensor or other means constitutes a two-dimensional gray image pattern representing the above-described digital data. It is to be noted that this two-dimensional gray image pattern can be classified into two types; the formation of a real image and a conjugate image of the digital data recorded on the hologram recording medium. Then, the digital data is demodulated from this two-dimensional gray image pattern with a decoder or other means to be able to reproduce the digital data.

As described above, FIG. 1 in Japanese Patent Application Laid-open Publication No. 2004-177958 shows a system operable to reproduce holograms from a hologram recording medium as described above.

<Optical System Adapted to Reproduce Real Image>

FIG. 10 illustrates an optical system (hereinafter referred to as “conventional example 1”) used for the angle-multiplexed recording and the real image reproduction in a hologram recording/reproduction apparatus.

First, in the optical system for angle-multiplexed recording, the reference beam strikes on the recording position of a hologram recording medium 50 via a scanner lens 52 at the incidence angle corresponding to the set angle of a mirror 51. On the other hand, the data beam, reflecting the two-dimensional gray image pattern formed in an SLM 53, strikes on the recording position of the hologram recording medium 50 via a PBS 54 and a Fourier transform lens 55. It is to be noted that the Fourier transform lens 55 causes the hologram recording medium 50 to record a hologram in the spectrum range based on the two-dimensional Fourier transform for the two-dimensional gray image pattern formed in the SLM 53. Thus, the reason why the Fourier transform lens 55 is used is because, even in the presence of noise in the optical path, the impact of such noise can be reduced by expanding into spectra.

For this reason, the optical system for the real image reproduction need to make adjustments including adjusting the angle of the mirror 51 to cause the reference beam, i.e., the beam having the same optical path as the reference beam used for the recording, to strike on the hologram recording medium 50. It is to be noted that, in this case, a real image reversed in direction to that of the recording for an image sensor 57 is obtained. On the other hand, the hologram recorded on the hologram recording medium 50 becomes a pattern in the spectrum range based on the Fourier transform lens 55. To obtain the original two-dimensional gray image pattern, inverse Fourier-transform processing is necessary to be performed on the image acquired by the image sensor 57. For this reason, a Fourier transform lens 56, identical in characteristic to the Fourier transform lens 55 used for the recoding, is necessary to be provided in the optical path through which the reproduction beam passing through the hologram recording medium 50 travels until the beam is received by the image sensor 57.

<Optical System Adapted to Reproduce Conjugate Image>

FIG. 11 illustrates an optical system (hereinafter referred to as “conventional example 2”) used for the angle-multiplexed recording and conjugate image reproduction in a hologram recording/reproduction apparatus. It is to be noted that like components of the conventional example 1 illustrated in FIG. 10 are given the same reference numerals.

To reproduce a conjugate image, the reference beam needs to strike on the hologram recording medium 50 from the opposite direction to that of the recording. For this reason, a mirror 58 and a scanner lens 59 are provided, as a mirror system adapted to generate the reproduction reference beam, in the optical path of the reference beam for the recording via the hologram recording medium 50, separately from the mirror system (mirror 51 and scanner lens 52) adapted to generate the recording reference beam. When a conjugate image is played back, the reproduction beam passes through the Fourier transform lens 55 and the PBS 54 again in the same optical path as that of the data beam for the recording, and is received by the image sensor 57 provided at the destination of the split beams from the PBS 54. Thus, in the case of playing back a conjugate image does not require a pair of the Fourier transform lenses 55 and 56 that are identical in characteristic.

Incidentally, although the conventional example 1 as shown in FIG. 10 must use the pair of the Fourier transform lenses 55 and 56 identical in characteristic, it involves extreme difficulties in manufacturing a pair of the Fourier transform lenses 55 and 56 with the same characteristic. Besides, the Fourier transform lenses 55 and 56 must be positioned with high precision. Thus, the conventional example 1 requires not only the high-precision Fourier transform lenses 55 and 56 but also the high-precision positioning thereof. This may lead to the so-called interchangeability problem characterized by failure to properly reproduce the hologram recorded by other hologram recording/reproduction apparatus.

On the other hand, the conventional example 2 as shown in FIG. 11 requires two mirror systems, one to generate the reference beam for the recording and the other to do so for the reproduction, in place of the pair of the Fourier transform lenses 55 and 56. These mirror systems are not strongly demanded to have the same characteristic as with the Fourier transform lenses 55 and 56. However, the reference beams for the recording and reproduction should generally have the same incidence angle. Therefore, high-precision mirror control is required. Besides, in case of the conventional example 2, since the data and reproduction beams pass through the same Fourier transform lens 55, the SLM 53 and the image sensor 57 are always required to have the same format. Thus, the optical system may become even more complicated in conventional example 2 than in conventional example 1.

As described above, there is a need for a complicated and highly precise optical system adopted in a hologram recording/reproduction apparatus, which is used for whichever the conventional examples 1 and 2.

### SUMMARY OF THE INVENTION

In order to overcome the above problems, according to an aspect of the present invention there is provided a hologram reproduction apparatus configured to reproduce a hologram, formed as an interference fringe by causing a coherent recording reference beam and a coherent data beam corresponding to image data to be recorded through a Fourier transform lens to strike on a hologram recording medium, based on a diffracted light obtained by causing a coherent reproduction reference beam to strike on the hologram recording medium, the hologram reproduction apparatus comprising a first optical system disposed on one side of the hologram recording medium to form an optical path of the reproduction reference beam using the same optical path as that of the recording reference beam; a second optical system disposed on the data beam optical path on the other side of the hologram recording medium that is opposed to the one side to receive a diffracted light obtained by causing the reproduction reference beam to strike on the hologram recording medium from the one side of the hologram recording medium and load captured image data corresponding to the image data; and a control unit operable to carry out an inverse Fourier transform processing on the captured image data loaded into the second optical system.

According to the present invention, there can be provided a hologram reproduction apparatus and a hologram reproduction method with a simplified optical system and an improved reproduction capability.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 illustrates a configuration of a hologram recording/reproduction apparatus according to an embodiment of the present invention;

FIG. 2 illustrates a configuration of optical systems of the hologram recording/reproduction apparatus according to an embodiment of the present invention;

FIG. 3 is an explanatory view of a coordinate adjustment of captured image data according to an embodiment of the present invention;

FIG. 4 is an explanatory view of the coordinate adjustment of captured image data according to an embodiment of the present invention;

FIG. 5 is an explanatory view of the coordinate adjustment of captured image data according to an embodiment of the present invention;

FIG. 6 is an explanatory view of an image size adjustment of captured image data according to an embodiment of the present invention;

FIG. 7 is an explanatory view of a trimming of captured image data according to an embodiment of the present invention;

FIG. 8 schematically illustrates how monomers transform into polymers in a hologram recording medium;

FIG. 9 is an explanatory view of a recording format in the hologram recording medium;

FIG. 10 illustrates a configuration of optical systems of a conventional hologram recording/reproduction apparatus; and

FIG. 11 illustrates a configuration of other optical systems of a conventional hologram recording/reproduction apparatus.

### DETAILED DESCRIPTION OF THE INVENTION

<Overall Configuration of Hologram Recording/ Reproduction Apparatus>

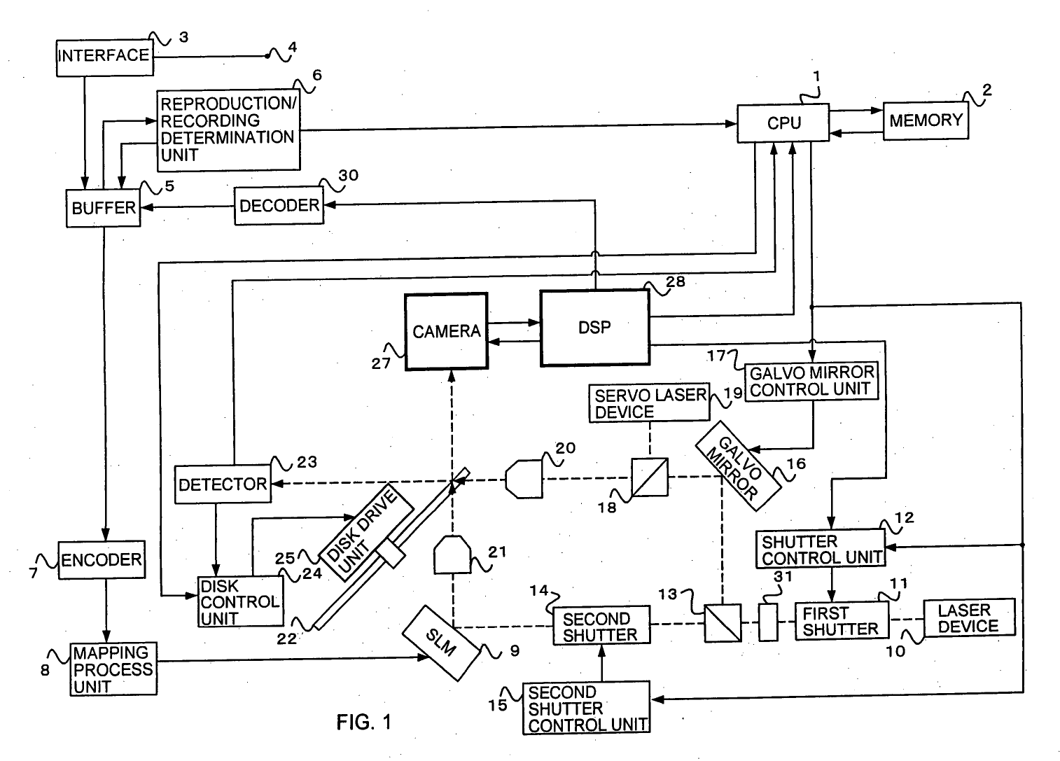

Description will be given below of the configuration of a hologram reproduction apparatus according to an embodiment of the present invention based on FIG. 1. It is to be noted that the hologram reproduction apparatus shown in FIG. 1 is assumed to be a hologram recording/reproduction apparatus that is capable of not only playing back holograms but also recording holograms.

The hologram recording/reproduction apparatus has a CPU 1, a memory 2, an interface 3, a connection terminal 4, a buffer 5, a reproduction/recording determination unit 6, an encoder 7, a mapping process unit 8, an SLM (Spatial Light Modulator) 9, a laser device 10, a first shutter 11, a first shutter control unit 12, a PBS (Polarization Beam Splitter) 13, a second shutter 14, a second shutter control unit 15, a galvo mirror 16, a galvo mirror control unit 17, a dichroic mirror 18, a servo laser device 19, a scanner lens 20, a Fourier transform lens 21, a detector 23, a disk control unit 24, a disk drive unit 25, a camera 27, a DSP (Digital Signal Processor) 28, a decoder 30 and a ½wavelength plate 31.

The interface 3 handles data exchange between host equipment (e.g., PC, workstation) connected via the connection terminal 4 and the hologram recording/reproduction apparatus.

The buffer 5 stores reproduction instruction data from the host equipment adapted to reproduce the data stored in a hologram recording medium 22. The buffer 5 also stores recording instruction data adapted to store the data from the host equipment in the hologram recording medium 22. The buffer 5 further stores the data to be recorded in the hologram recording medium 22.

The reproduction/recording determination unit 6 determines at a specified timing whether a reproduction or recording instruction signal is recorded in the buffer 5. When determining that a reproduction instruction signal is stored in the buffer 5, the reproduction/recording determination unit 6 sends an instruction signal to carry out the reproduction process in the hologram recording/reproduction apparatus to the CPU 1. On the other hand, when determining that a recording instruction signal is stored in the buffer 5, the reproduction/recording determination unit 6 sends an instruction signal to carry out the recording process in the hologram recording/reproduction apparatus to the CPU 1 to cause the buffer 5 to send the data to be recorded in the hologram recording medium 22 from the host equipment to the encoder 7. Further, the reproduction/recording determination unit 6 sends data volume information to be recorded in the hologram recording medium 22 to the CPU 1.

The encoder 7 carries out the encoding process on the data from the buffer 5 such as adding error correction code thereto.

The mapping process unit 8 rearranges the data from the encoder 7 into two-dimensional data array (e.g., 1280 bits down×1280 bits across≈1.6 Mbits) to form unit page array data.

The SLM 9 forms a two-dimensional gray image pattern based on the unit page array data formed by the mapping process unit 8. The two-dimensional gray image pattern refers to a pattern, for example, by taking one of the bit value (1) as a light spot (light) and the other bit value (0) as a dark spot (shade) in which they constitute the unit page array data. Supposing that the SLM 9 can create a two-dimensional gray image pattern with 1280 pixels down by 1280 pixels across, the SLM 9 transforms the approximately 1.6-Mbit data from the mapping process unit 8 into a two-dimensional gray image pattern with every piece of one-pixel data represented as a light or dark spot corresponding to one bit data. When the laser beam from the laser device 10 strikes on the SLM 9 as described later, the SLM 9 reflects the beam toward the Fourier transform lens 21. This reflected beam turns into a laser beam (hereinafter referred to as “data beam”) reflecting the two-dimensional gray image pattern formed by the SLM 9.

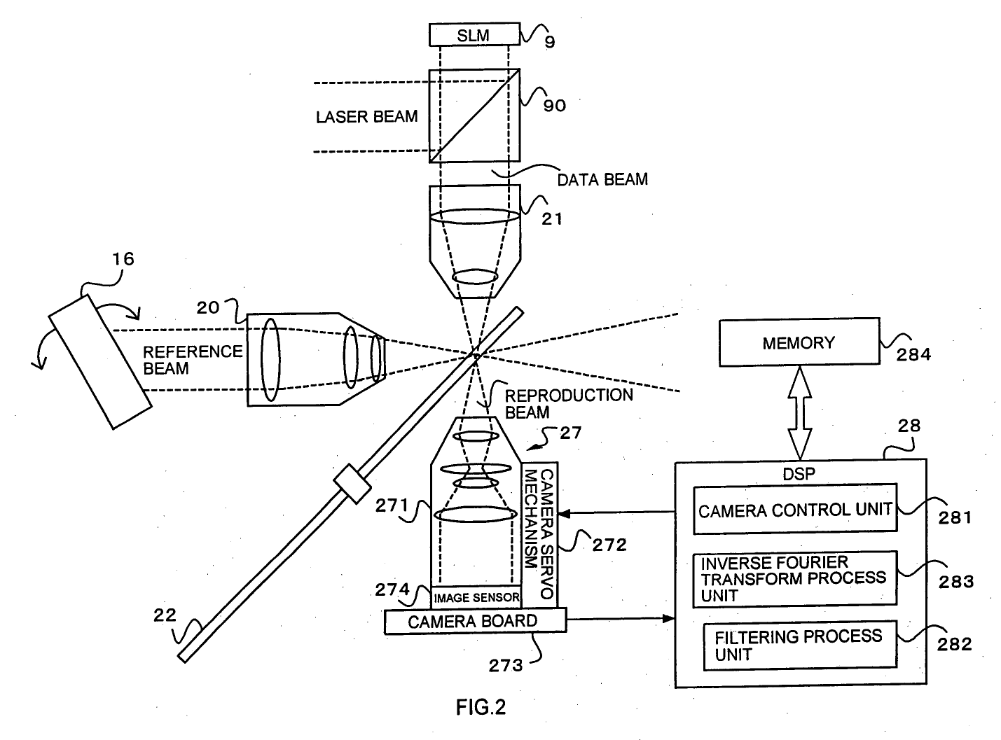

It is to be noted that the present invention is not limited to the case that the other laser beam from the PBS 13 directly strikes on the SLM 9 as shown in FIG. 1. For example, as shown in FIG. 2, a PBS 90 may be provided in the optical path between the second shutter 14 and the SLM 9 such that the laser beam split by the PBS 90 strikes on the SLM 9.

The laser device 10 emits a coherent laser beam, excellent in time and space coherence, to the first shutter 11. Among the lasers used for the laser device 10 to form a hologram on the hologram recording medium 22 are, for example, helium-neon laser, argon-neon laser, helium-cadmium laser, semiconductor laser, dye laser and ruby laser.

The CPU 1 exercises centralized control over the hologram reproduction apparatus. Upon receiving an instruction signal based on the recording instruction data from the reproduction/recording determination unit 6, the CPU 1 reads, from the memory 2, the address information based on the pit already formed on the hologram recording medium 22. Then, the CPU 1 sends an instruction signal to the disk control unit 24 to rotate the hologram recording medium 22 so as to irradiate the laser beam from the servo laser device 19 (hereinafter referred to as “servo laser beam”) onto the pit on the hologram recording medium 22 representing the next address information.

Further, the CPU 1 sends an instruction signal to the galvo mirror control unit 17 to cause this unit to adjust the angle of the galvo mirror 16.

Furthermore, the CPU 1 calculates the number of holograms (i.e., number of pages) formed on the hologram recording medium 22 based on the data volume information from the reproduction/recording determination unit 6. On the other hand, the CPU 1 sends an instruction signal to each of the first and second shutter control units 12 and 15 so as to respectively open the first and second shutters 11 and 14. As a result, it initiates the hologram recording to the hologram recording medium 22. Then, at the end of the recording process based on the recording instruction data, an instruction signal is sent to each of the first and second shutter control unit 12 and 15 so as to respectively close the first and second shutters 11 and 14. This terminates the hologram recording to the hologram recording medium 22.

On the other hand, upon receiving an instruction signal based on the reproduction instruction data from the reproduction/recording determination unit 6, the CPU 1 sends an instruction signal to rotate the hologram recording medium 22 to the disk control unit 24 so as to irradiate the servo laser beam from the servo laser device 19 onto the pit on the hologram recording medium 22 representing the address information that corresponds to the reproduction instruction signal. Further, upon receiving an instruction signal based on the reproduction instruction data, the CPU 1 sends an instruction signal to the first shutter control unit 12 to open the first shutter 11 and another instruction signal to the second shutter control unit 15 to close the second shutter 14. The CPU 1 also sends an instruction signal to the galvo mirror control unit 17 to cause this unit to adjust the angle of the galvo mirror 16. As a result, it initiates the hologram reproduction from the hologram recording medium 22. Then, when determining that the given period of time has elapsed in the reproduction process based on the reproduction instruction data, the CPU 1 sends an instruction signal to the first shutter control unit 12 to close the first shutter 11. As a result, it terminates the hologram reproduction from the hologram recording medium 22. It is to be noted that the CPU 1 may terminate the reproduction process in response to the signal based on the determination result from the DSP 28.

The first shutter control unit 12 exercises control so as to open or close the first shutter 11 based on the instruction signal from the CPU 1. The first shutter control unit 12 also exercises control so as to close the first shutter 11 based on the instruction signal from the DSP 28. When opening the first shutter 11, the first shutter control unit 12 sends an opening instruction signal to the first shutter 11. Further, when closing the first shutter 11, the first shutter control unit 12 sends a closing instruction signal to the first shutter 11.

The first shutter 11 opens based on the opening instruction signal from the first shutter control unit 12. Alternatively, the first shutter 11 closes based on the closing instruction signal from the first shutter control unit 12. When the first shutter 11 closes, the laser beam from the laser device 10 is interrupted from striking on the ½ wavelength plate 31.

The ½ wavelength plate 31 is provided at a given inclination so as to determine the angle for the laser beam from the laser device 10 to strike on the PBS 13. It is to be noted that this given inclination is determined so as to achieve a desired split ratio of the two laser beams split by the PBS 13.

The PBS 13 splits the laser beam from the ½ wavelength plate 31 into two laser beams. One of the laser beams split by the PBS 13 strikes on the second shutter 14. On the other hand, the other laser beam (hereinafter referred to as “reference beam”) strikes on the galvo mirror 16.

The galvo mirror 16 reflects the reference beam from the PBS 13 to the dichroic mirror 18.

The galvo mirror control unit 17 controls the angle of the galvo mirror 16 so as to adjust the angle for the reference beam, reflected by the galvo mirror 16, to strike on the hologram recording medium 22 via the dichroic mirror 18 and the scanner lens 20, based on the instruction signal from the CPU 1. This angle adjustment of the galvo mirror 16 by the galvo mirror control unit 17 is carried out during the recording to the hologram recording medium 22 to ensure that the two-dimensional gray image pattern information is recorded on the hologram recording medium 22 as a hologram.

More specifically, a three-dimensional interference fringe (hologram) is formed as a result of the interference between the data and reference beams within the hologram recording medium 22. That is, as a result of the formation of a hologram on the hologram recording medium 22, the two-dimensional gray image pattern information set in the SLM 9 is recorded. Further, the galvo mirror control unit 17 adjusts the angle of the galvo mirror 16, that is, changes the incidence angle of the reference beam onto the hologram recording medium 22, to enable the angle-multiplexed recording. One hologram formed on the hologram recording medium 22 is hereinafter referred to as a page, and a multiplexed recorded hologram with a number of pages one above the other created by the angle-multiplexed recording is referred to as a book.

During the reproduction from the hologram recording medium 22, the galvo mirror control unit 17 adjusts the angle of the galvo mirror 16 so as to cause the reference beam to strike on the hologram formed on the hologram recording medium 22. This angle adjustment of the galvo mirror 16 by the galvo mirror control unit 17 is carried out during the reproduction to ensure that the reference beam strikes on the hologram, formed based on data to be played back, at the same incidence angle as the reference beam used to form the data to be played back as the hologram.

The servo laser device 19 emits a servo laser beam to the dichroic mirror 18 so as to irradiate the beam onto a pit provided on the hologram recording medium 22 and detect the position of the hologram formed on the medium 22 based on the address information represented by the pit. The servo laser beam emitted from the servo laser device 19 is a beam at a specific wavelength that does not affect the hologram formed on the hologram recording medium 22. It is to be noted that a blue laser beam is used as the beam emitted from the laser device 10 and that a red laser beam, longer in wavelength than the blue laser beam, is used as the servo laser beam.

The emission of the servo laser beam from the servo laser device 19 begins, for example, when the hologram recording/reproduction apparatus starts its operation, and the servo laser device 19 continues to emit the servo laser beam while the hologram recording/reproduction apparatus remains in operation. Although the servo laser device 19 is assumed to continue its emission, the present invention is not limited thereto. During the data recording to the hologram recording medium 22 by the hologram recording/reproduction apparatus, for example, the hologram recording medium 22 pauses. For this reason, the irradiation of the servo laser beam by the servo laser device 19 may be halted during the period of time when the irradiation of the beam onto the pit is not necessarily required. This can reduce the load caused by the emission of the servo laser beam from the servo laser device 19.

The dichroic mirror 18 transmits the reference beam reflected by the galvo mirror 16 to cause the reference beam to strike on the scanner lens 20. Further, the dichroic mirror 18 reflects the servo laser beam emitted from the servo laser device 19 to cause the laser beam to strike on the scanner lens 20.

The scanner lens 20 refracts the reference beam, i.e., the beam incident via the dichroic mirror 18 from the galvo mirror 16 that has been adjusted in angle by the galvo mirror control unit 17, so as to ensure the irradiation of the beam onto the hologram recording medium 22. The scanner lens 20 also causes the servo laser beam from the servo laser device 19, reflected by the dichroic mirror 18, to strike on the hologram recording medium 22.

The second shutter control unit 15 exercises control so as to open or close the second shutter 14 based on the instruction signal from the CPU 1. When opening the second shutter 14, the second shutter control unit 15 sends an opening instruction signal to the second shutter 14. When closing the second shutter 14, on the other hand, the second shutter control unit 15 sends a closing instruction signal to the second shutter 14.

The second shutter 14 opens based on the opening instruction signal from the second shutter control unit 15. Alternatively, the second shutter 14 closes based on the closing instruction signal from the second shutter control unit 15. When the second shutter 14 closes, one of the laser beams split by the PBS 13 is interrupted from striking on the SLM 9. It is to be noted that the second shutter 14 may be provided in the optical path of the data beam from the SLM 9 incident upon the hologram recording medium 22 via the Fourier transform lens 21.

The Fourier transform lens 21 first subjects the data beam to the Fourier transform process and then causes the beam to strike on the hologram recording medium 22 while collecting the data beam from the SLM 9.

A photosensitive resin (e.g., photopolymer, silver salt emulsion, gelatine bichromate, photoresist), capable of storing data as a hologram, is used for the hologram recording medium 22. This resin is sealed between glass substrates to configure the hologram recording medium 22. A hologram is formed on the hologram recording medium 22 as a result of the interference between the Fourier-transformed data beam from the Fourier transform lens 21 representing a two-dimensional gray image pattern and the reference beam from the scanner lens 20. Then, following the angle adjustment of the galvo mirror 16 by the galvo mirror control unit 17, a hologram is formed again as a result of the interference between the reference beam from the galvo mirror 16 and the data beam. This allows the angle-multiplexed recording to be carried out, thus forming a book on the hologram recording medium 22.

On the other hand, wobbles are, for example, formed in advance on the glass substrates making up the hologram recording medium 22 so that address information is formed in advance in the wobbles as pits to determine the positions of the holograms formed on the hologram recording medium 22. Then, the servo laser beam, incident from the scanner lens 20 and emitted from the servo laser device 19, is irradiated onto the pit representing the address information. After the irradiation onto the pit representing the address information, the servo laser beam strikes on the detector 23.

A beam (hereinafter referred to as “reproduction beam”), resulting from the diffraction of the reference beam by the hologram representing a Fourier-transformed two-dimensional gray image pattern, directly strikes on the camera 27 during the data reproduction from the hologram recording medium 22. It is to be noted that the reproduction beam contains the Fourier-transformed two-dimensional gray image pattern information based on the hologram at the time of the diffraction of the reference beam, depending on the incidence angle at which the reference beam struck the hologram recording medium 22.

Therefore, the camera 27 forms an optical image corresponding to the two-dimensional gray image pattern set in the SLM 9 from the incident reproduction beam. The camera 27 also sends image data (hereinafter referred to as “captured image data”) in analog amounts corresponding to the light intensity of the light or shade of the formed optical image based on the instruction signal from the DSP 28.

The DSP 28 exercises servo control to servo-drive the camera 27 so as to load desired captured image data into the camera 27 based on parameters including the given coordinate position, magnification and light intensity. Here, the DSP 28 determines whether the desired captured image data has been reproduced in the camera 27 and that the DSP 28 sends a signal based on the determination result to the CPU 1. The DSP 28 also sends an instruction signal to the first shutter control unit 12 to close the first shutter 11 when determining that the desired captured image data has been reproduced in the camera 27. Then, the DSP 28 subjects the reproduced captured image data to the given filtering process first and then further to the inverse Fourier transform process.

The decoder 30 carries out the error correction and other decoding processes on the captured image data that has undergone various processes by the DSP 28.

The detector 23 receives the servo laser beam emitted from the servo laser device 19 after the irradiation of the beam onto the pit representing the address information formed on the hologram recording medium 22. The detector 23 is, for example, made up of a four-part photodiode to send the light intensity information of the servo laser beam detected by the four-part photodiode to the disk control unit 24. The detector 23 also sends the address information to the CPU 1 based on the servo laser beam irradiated onto the pit representing the address information.

The disk control unit 24 servo-controls the disk drive unit 25 based on the light intensity information of the servo laser beam from the detector 23. The disk control unit 24 also sends an instruction signal to the disk drive unit 25 to rotate the hologram recording medium 22 during the reproduction (or recording) so as to irradiate the servo laser beam onto the pit representing the desired address information of the hologram recording medium 22 based on the instruction signal from the CPU 1. The disk control unit 24 also sends an instruction signal to the disk drive unit 25 to rotate the hologram recording medium 22 so as to allow the formation of a hologram at other position of the hologram recording medium 22 when the book is formed on the hologram recording medium 22.

The memory 2 stores in advance the program data used by the CPU 1 to proceed with the above-described processes. The memory 2 also stores the address information from the pits formed on the hologram recording medium 22 from the CPU 1. The memory 2 is made up of a non-volatile storage element that can be repeatedly written and read by electrically deleting the data.

<Optical Systems of Hologram Recording/Reproduction Apparatus>

Detailed description will be given below of the optical systems of the hologram recording/reproduction apparatus according to an embodiment of the present invention based on FIG. 2. It is to be noted that the optical systems shown in FIG. 2 are designed to enable not only the angle-multiplexed recording achieved through the angle adjustment of the galvo mirror 16 but also the real image reproduction accomplished using the same optical path for the recording and reproduction reference beams (i.e., the same incidence angle for the two beams).

First, as for the optical system for the angle-multiplexed recording, the data beam reflecting the two-dimensional gray image pattern formed in the SLM 9 strikes on the recording position on one side of the hologram recording medium 22 via the PBS 90 and the Fourier transform lens 21. On the other hand, a reference beam (hereinafter referred to as “recording reference beam”) strikes on the recording position on one side of the hologram recording medium 22 via the scanner lens 20 at the incidence angle corresponding to the angle set in the galvo mirror 16. As a result, it allows for the multiplexed recording of holograms on the hologram recording medium 22 in the spectrum range based on the Fourier transform of the two-dimensional gray image pattern formed in the SLM 9.

As for the optical system for the real image reproduction, on the other hand, a reference beam passing through the same optical path as the recording reference beam (hereinafter referred to as “reproduction reference beam”) must be caused to strike on one side of the hologram recording medium 22 through adjustments including the angle adjustment of the galvo mirror 16. For this reason, the optical system forming the optical path of the reproduction reference beam is provided on one side of the hologram recording medium 22 as with the optical system forming the optical path of the data beam. Thus, the same optical path is formed for the reproduction and recording reference beams. The optical system forming the optical path of the reproduction reference beam comprises, for example, the galvo mirror 16, the PBS 18 and the scanner lens 20 as shown in FIG. 1. Here, the optical system forming the optical path of the reproduction reference beam is an embodiment of a “first optical system” according to the present invention.

The camera 27 is also provided in the optical path of the data beam on the other side of the hologram recording medium 22 so as to receive the diffracted beam (reproduction beam) obtained as a result of the reproduction reference beam striking on one side of the hologram recording medium 22 and load the captured image data. Here, the camera 27 is an embodiment of a “second optical system” according to the present invention.

The camera 27 comprises the optical system of a zoom lens 271 with a variable focal distance, a camera servo mechanism 272 operable to enable various servo drives, a camera board 273 provided with an image sensor 274 such as CCD sensor or CMOS sensor and other components, and is equipped with the zoom and trimming functions. The camera 27 forms an optical image corresponding to the two-dimensional gray image pattern set in the SLM 9 from the incident reproduction beam via the zoom lens 271, and generates the captured image data through the photoelectric conversion achieved by the image sensor 274 on the camera board 273.

The DSP 28 has a camera control unit 281, an inverse Fourier transform processing unit 282 and a filtering process unit 283. Further, the DSP 28 can access a specific memory 284. Here, the DSP 28 is an embodiment of a “control unit” according to the present invention. It is to be noted that the “control unit” according to the present invention is not limited to the DSP 28 and may be the CPU 1 or the circuit integrated on the camera board 273.

The camera control unit 281 exercises control to servo-drive the camera 27 so as to properly load the desired captured image data. Such control includes position servo control adapted to set the camera 27 at a given coordinate position and the zoom servo control adapted to set the zoom lens 271 to a given magnification factor. Further, the camera control unit 281 conducts zoom servo control to enlarge the image size of the captured image data to the specified magnification factor and proceeds with the so-called trimming process used to load the specified area of the captured image data enlarged by the zoom servo control. Furthermore, the camera control unit 281 can correct the captured image data to correct the aberration of various lenses in the optical paths of the data and reference beams.

The inverse Fourier transform processing unit 282 is designed to subject the captured image data to the inverse Fourier transform processing after the A/D conversion. That is, the data beam passes through the Fourier transform lens 21 during the hologram recording. Therefore, a two-dimensional-Fourier-transformed two-dimensional gray image pattern is recorded on the hologram recording medium 22. Here, the Fourier transform relative to orthogonal coordinates g (x, y) in a two-dimensional space is expressed by formula 1 as follows:

$$\begin{matrix}F \{ g ( x , y ) \} = {\int }_{- ∞}^{ ∞} {\int }_{∞}^{ ∞} g ( x , y ) exp [ i 2 π ( ξ x + η y ) ] ⅆ x ⅆ y \\ = G ( ξ , η )\end{matrix} \qquad ( Formula 1 )$$

where ξ and η are space frequencies.

Here, the inverse Fourier transform processing unit 282 proceeds with the inverse Fourier transform process as expressed by formula 2 shown below to remove the effect of the two-dimensional Fourier transform by the Fourier transform lens 21 from the A/D-converted captured image data. It is to be noted that this inverse Fourier transform process is conducted in conformity with the fast Fourier transform algorithm.

$$\begin{matrix}{F}^{- 1} \{ G ( ξ , η ) \} = {\int }_{- ∞}^{ ∞} {\int }_{- ∞}^{ ∞} G ( ξ , η ) exp [ i 2 π ( ξ x + η y ) ] ⅆ ξ ⅆ η \\ = g ( x , y )\end{matrix} \qquad ( Formula 2 )$$

The filtering process unit 283 subjects the inverse-Fourier-transformed captured image data to the given filtering process to enhance the separability of the binarization process by the decoder 30. That is, the captured image data reproduced by the camera 27 may fail to reproduce the lightness or darkness as clearly as the two-dimensional gray image pattern formed by the SLM 9 due to, for example, noise to which the data and reproduction beams are subjected. This may result in failure to determine whether the captured image data reproduced by the camera 27 is at the level representing ‘lightness’ or ‘darkness’, thus leading to an inappropriate decoding process. For this reason, the filtering process unit 283 corrects the level of the captured image data with its filtering process.

The memory 284 is a storage element operable to store control information used for various types of control carried out by the camera control unit 281. It is to be noted that the memory 284 may also serve as the memory 2 accessible by the CPU 1.

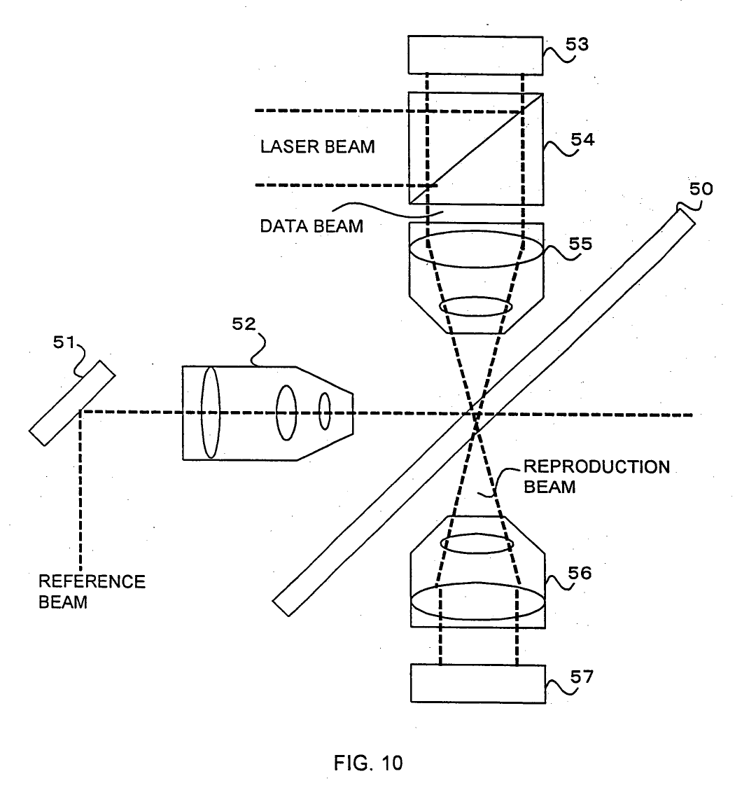

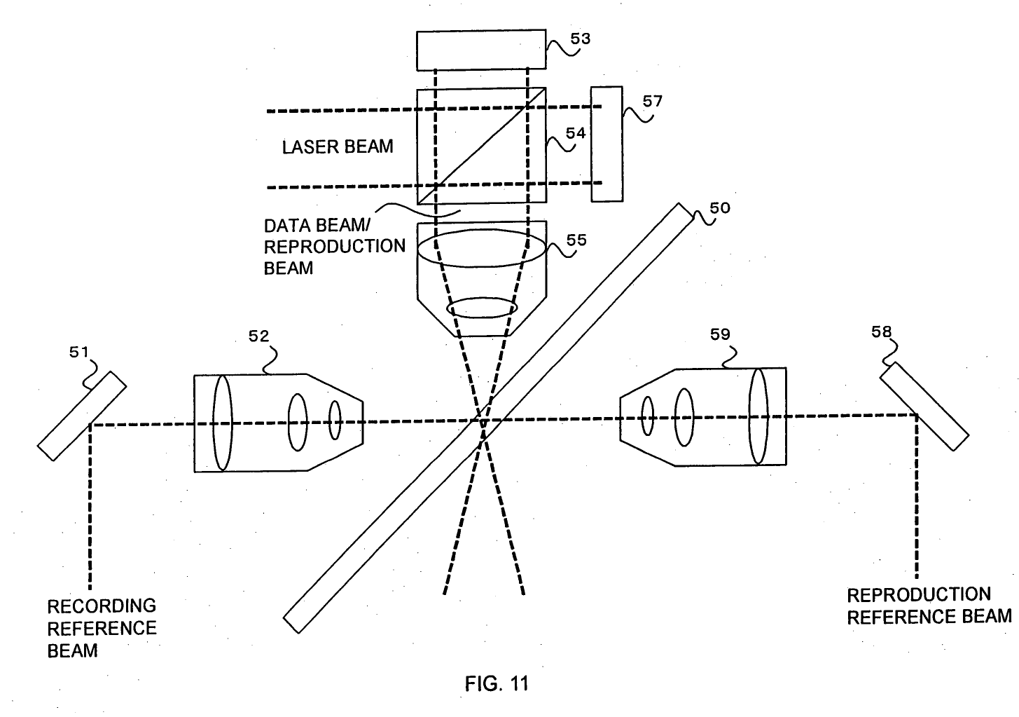

Thus, the hologram recording/reproduction apparatus according to the present invention is provided with the optical system operable to form the optical path of the reproduction reference beam having the same optical path as the recording reference beam and reproduce a real image. Further, instead of the Fourier transform lenses (55 and 56), provided one on each side of the hologram recording medium 50, as shown in FIG. 10, one such lens is provided only on one side of the hologram recording medium 22 that receives the data beam and the recording or reproduction reference beam. The camera 27 is provided instead of the Fourier transform lens 56 on the other side of the hologram recording medium 22 so that the camera 27 directly loads the captured image data without the mediation of the Fourier transform lens 56. Then, the DSP 28 is provided to inverse-Fourier-transform the captured image data.

Therefore, the removal of the Fourier transform lens 56, provided on the other side of the hologram recording medium 50, eliminates the restriction of having to provide a pair of the Fourier transform lenses (55 and 56) as compared with conventional example 1 shown in FIG. 10. As compared with conventional example 2, on the other hand, the adoption of the optical system operable to form a real image reproduction having the same optical path for the recording and reproduction reference beams eliminates the need for the high-precision mirror control required to set the recording and reproduction reference beams at the same incidence angle. Thus, the hologram recording/reproduction apparatus according to the present invention provides simpler optical systems than the conventional examples 1 and 2. Such simplified optical systems make the apparatus less prone to noise deriving, for example, from the lens aberration and displacement from the installed position, thus enabling improved integrity of the hologram reproduction.

Further, the hologram recording/reproduction apparatus according to the present invention uses the DSP 28 to servo-drive the zoom lens 271 or the camera 27 itself so as to properly load the captured image data prior to the inverse Fourier transform process. This can resolve the distortion or displacement of the captured image data caused by the manufacturing variations and position displacement of the Fourier transform lens remaining on the data beam incidence side. This also ensures more reliable loading of the captured image data through the servo-driving of the zoom lens 271 or the camera 27 itself even in the case of the hologram reproduction from the hologram recording medium 22 with a hologram recorded by other hologram recording apparatus, thus improving the so-called interchangeability. Further, the Fourier transform lens 21 left on the data beam incidence side ensures a fast Fourier transform on this side.

<Coordinate Adjustment of Captured Image Data>

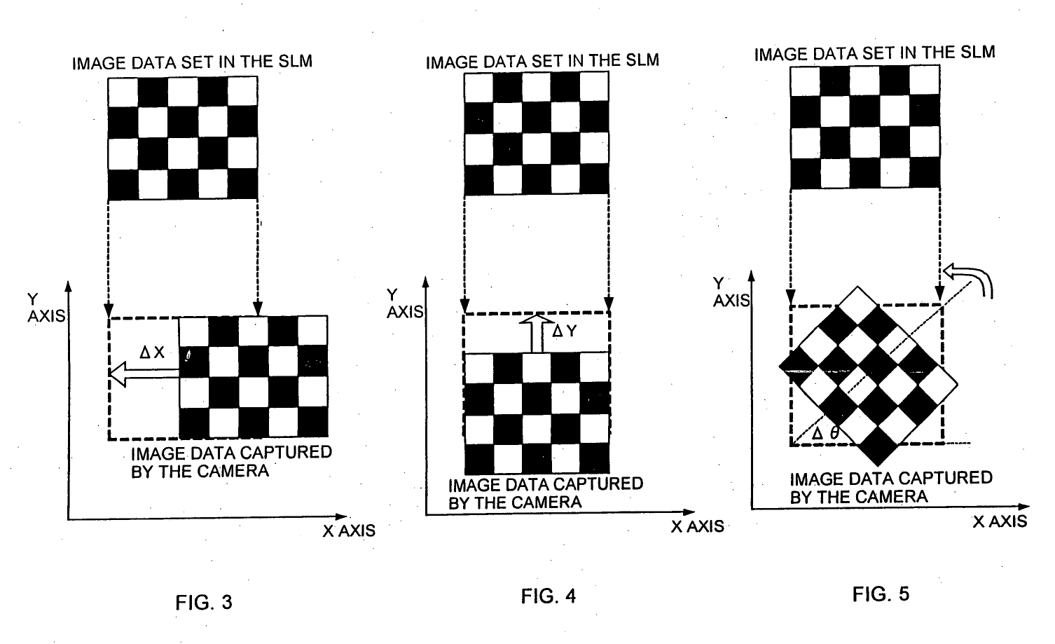

Description will be given below of the coordinate adjustment of the captured image data carried out in the DSP 28 and the camera 27 based on FIGS. 3, 4, and 5.

For example, that the zoom lens 27 has a displacement from the installed position relative to the optical path of the reproduction beam formed based on the reproduction reference beam. In this case, the captured image data loaded into the camera 27 naturally has a displacement in coordinate position. For instance, the captured image data may have a displacement along the X axis even when the X and Y axes are set in the image sensor 274 of the camera board 273 as shown in FIG. 3. In the same manner, the captured image data may have a displacement along the Y axis as shown in FIG. 4. Further, the data may have a displacement along a rotation direction θ of the circle's circumference defined based on the X and Y axes as shown in FIG. 5.

In these cases, the DSP 28 uses the camera control unit 281 to control the position servo along the X and Y axes and the rotation direction of the camera servo mechanism 272 to adjust the coordinate position of the captured image data. For instance, the DSP 28 uses an arbitrary pixel in the captured image data reproduced by the camera 27 as a target mark to determine whether the target mark coincides with a given position of the image sensor on the camera board 273. Then, after the coordinate adjustment following the position servo control, the captured image data undergoes the inverse Fourier transform and filtering processes.

Thus, an arrangement is provided for the DSP 28 to drive the position servo of the camera servo mechanism 272 with the camera control unit 281 so as to adjust the coordinate position of the captured image data. As a result, it allows resolving the coordinate position displacement of the captured image data, thus ensuring an improved hologram reproduction performance. Moreover, the so-called interchangeability can be improved to ensure a more reliable reproduction of holograms with other hologram reproduction apparatuses.

<Image Size Adjustment of Captured Image Data>

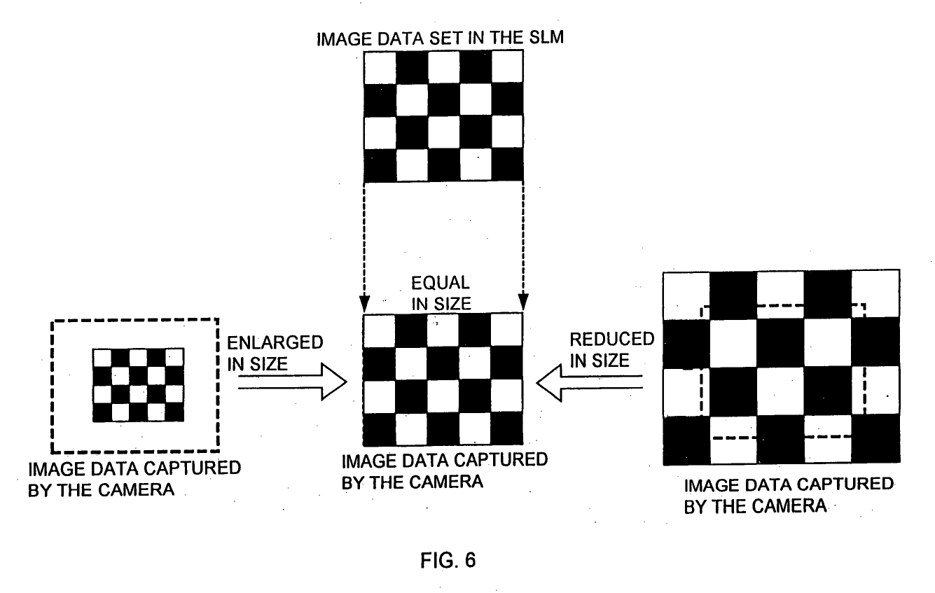

Description will be given below of the image size adjustment of the captured image data conducted by the DSP 28 and the camera 27 based on FIG. 6.

For example, the image size of the captured image data loaded into the camera 27 may need to be enlarged or reduced in size because it does not match the image size of the two-dimensional gray image pattern (1280 pixels down by 1280 pixels across) set in the SLM 9 as shown in FIG. 6 due to noise-related causes based on the lens aberration and displacement from the installed position in the optical paths of the reproduction reference beam and the reproduction beam. Further, if the hologram recording/reproduction apparatus according to the present invention provided with the Fourier transform lens 21 having a Y. YY magnification factor plays back a hologram from the hologram recording medium 22 recorded via the Fourier transform lens 21 having a different X. XX magnification factor using other hologram recording/reproduction apparatus, the actual size of the hologram recorded on the hologram recording medium 22 may possibly fail to be compatible with the image size of the captured image data.

For this reason, the DSP 28 exercises control over the zoom servo of the camera servo mechanism 272 so as to enlarge or reduce the image size of the captured image data loaded into the camera 27 with the camera control unit 281 and ensure that the image size of the captured image data is compatible with the image size information (e.g., pixels, pitches) of the two-dimensional gray image pattern stored in advance in the memory 284. Then, after the image size adjustment following the zoom servo control, the captured image data undergoes the inverse Fourier transform and filtering processes.

It is to be noted that when the hologram recording/reproduction is conducted alone with the hologram recording/reproduction apparatus according to the present invention, the image size information of the two-dimensional gray image pattern set during the hologram recording is stored in the memory 284 in preparation for the image size adjustment of the captured image data during the hologram reproduction.

On the other hand, if the hologram recording/reproduction apparatus according to the present invention plays back a hologram from the hologram recording medium 22 recorded by other hologram recording/reproduction apparatus, the recorded image information (e.g., image size information of the two-dimensional gray image pattern) on the hologram recording by the other hologram recording/reproduction apparatus is transferred in advance to the memory 284.

Here, the hologram recording medium 22 is photosensitive. Therefore, the embodiment is designed to accommodate the hologram recording medium 22 inside a light-interrupting container such as a cartridge so as to interrupt the light to the hologram recording medium 22 under a normal condition. For this reason, if the interchangeability with other models is assumed, a given memory is installed in the light-interrupting container accommodating the hologram recording medium 22, and that the recorded image information is stored in the given memory inside the light-interrupting container during the hologram recording. Further, the hologram recording/reproduction apparatus according to the present invention is designed to transfer the image information to the memory 284 via the given memory inside the light-interrupting container during the hologram reproduction. It is to be noted that contact and noncontact (e.g., RFID system) transfer systems can be used to transfer the recorded image information from the given memory within the light-interrupting container to the memory 284.

It is to be noted that when the physical format of the hologram recording medium 22 is finalized in the future, a hologram can be recorded together with its recorded image information on the hologram recording medium 22 so that the recorded image information is played back from the hologram recording medium 22 and stored in the memory 284 during the hologram reproduction.

Thus, an arrangement is provided for the DSP 28 to drive the zoom servo of the camera servo mechanism 272 with the camera control unit 281 so as to adjust the image size of the captured image data. This allows resolving the image size discrepancy of the captured image data, thus ensuring an improved hologram reproduction performance. This also eliminates the need to ensure a match in advance between the image size of the two-dimensional gray image pattern set in the SLM 9 and that of the captured image data loaded into the camera 27, as has been conventionally done. Further, this ensures improvement in the so-called interchangeability, i.e., a feature that provides a better hologram reproduction with other hologram reproduction apparatuses.

<Trimming of Captured Image>

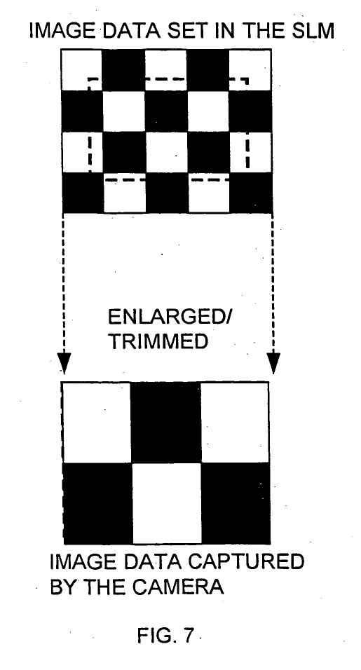

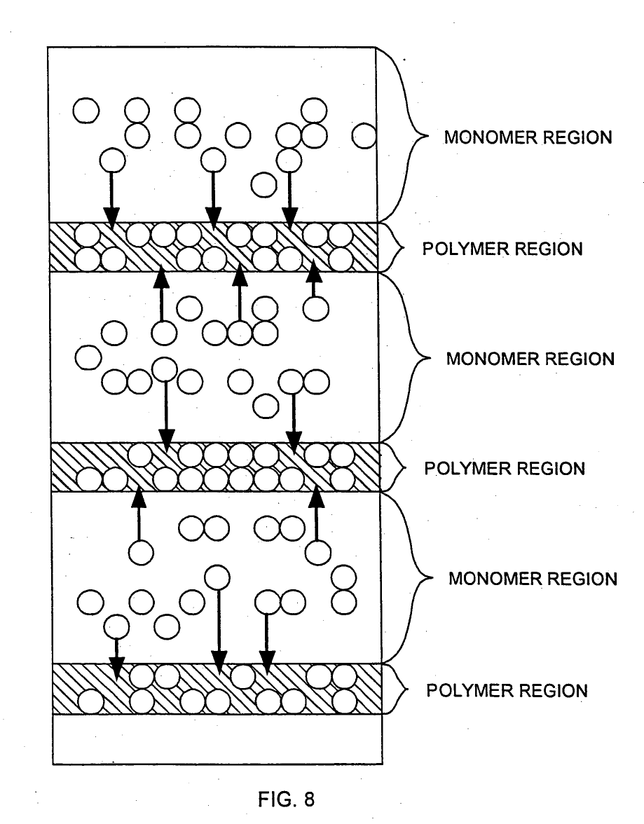

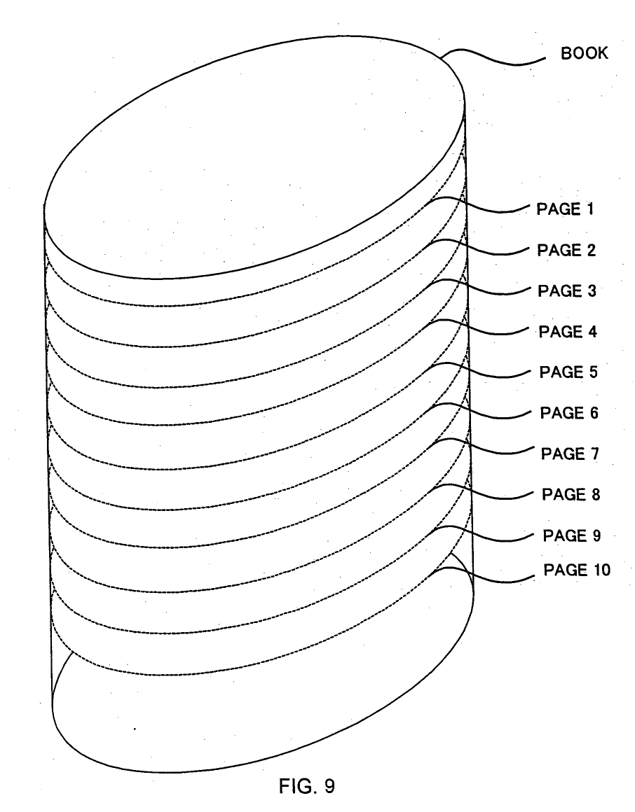

Description will be given below of the trimming of the captured image data conducted in the DSP 28 and the camera 27 based on FIG. 7.

For example, one may wish to enlarge and cut out part of the captured image data loaded into the camera 27 to analyze it at a high resolution.

For this reason, the DSP 28 controls the zoom servo of the camera servo mechanism 272 so as to enlarge the image size of the captured image data loaded into the camera 27 by the camera control unit 281 to the specified magnification factor. Further, the DSP 28 loads part (specified area) of the captured image data enlarged to the specified magnification factor by the camera control unit 281. Then, the DSP 28 proceeds with the inverse Fourier transform and filtering processes on the part of the loaded captured image data.

Thus, an arrangement is provided for the DSP 28 to drive the zoom servo of the camera servo mechanism 272 with the camera control unit 281 so as to trim the captured image data. As a result, it allows processing the captured image data at a high resolution. This also ensures improvement in the so-called upper compatibility, i.e., a feature that enables hologram reproduction even in the event of future changes in hologram pixel count and configuration as a result of specification changes for hologram recording/reproduction apparatuses.

While embodiments of the present invention have been described hereinabove, it should be understood that the aforementioned embodiments are intended to facilitate the understanding of the present invention and not to be construed as restrictive. The present invention can be changed or modified without departing from the spirit of the invention and encompasses equivalents thereof.

What is claimed is:

1. A hologram reproduction apparatus configured to reproduce a hologram, formed as an interference fringe by causing a coherent recording reference beam and a coherent data beam corresponding to image data to be recorded after passing through a Fourier transform lens to strike on a hologram recording medium, based on a diffracted light obtained by causing a coherent reproduction reference beam to strike on the hologram recording medium, the hologram reproduction apparatus comprising:
a first optical system disposed on one side of the hologram recording medium to form an optical path of the reproduction reference beam using the same optical path as that of the recording reference beam;
a second optical system disposed on the data beam optical path on the other side of the hologram recording medium that is opposed to the one side to receive a diffracted light obtained by causing the reproduction reference beam to strike on the one side of the hologram recording medium from the one side of the hologram recording medium and load captured image data corresponding to the image data; and
a control unit operable to carry out an inverse Fourier transform process on the captured image data loaded into the second optical system.

2. The hologram reproduction apparatus of claim 1, wherein the second optical system includes a zoom lens optical system and a servo mechanism operable to drive the zoom lens optical system, and wherein the control unit servo-controls the servo mechanism to properly load the captured image data prior to the inverse Fourier transform process.

3. The hologram reproduction apparatus of claim 2, wherein the servo mechanism includes a zoom servo mechanism operable to adjust the zoom of the zoom lens optical system, and wherein the control unit servo-controls the zoom servo mechanism to ensure compatibility between the image size of the captured image data and that of the image data prior to the inverse Fourier transform process.

4. The hologram reproduction apparatus of claim 2, wherein the servo mechanism includes a zoom servo mechanism operable to adjust the zoom of the zoom lens optical system, and wherein the control unit servo-controls the zoom servo mechanism to enlarge the image size of the captured image data to a specified magnification factor and carries out the inverse Fourier transform process after loading a part of the captured image data enlarged by the servo control.

5. The hologram reproduction apparatus of claim 2, wherein the servo mechanism includes a position servo mechanism operable to adjust the installed position of the zoom lens optical system, and wherein the control unit servo-controls the position servo mechanism to adjust the coordinate position of the captured image data prior to the inverse Fourier transform process.

6. A hologram reproduction method for reproducing holograms, formed as an interference fringe by causing a coherent recording reference beam and a coherent data beam corresponding to image data to be recorded after passing through a Fourier transform lens to strike on a hologram recording medium, based on a diffracted light obtained by causing a coherent reproduction reference beam to strike on the hologram recording medium, the hologram reproduction method comprising:
causing the reproduction reference beam to strike on the hologram recording medium through the same optical path as that of the recording reference beam from one side of the hologram recording medium;
receiving a diffracted light obtained by causing the reproduction reference beam to strike on the one side of the hologram recording medium from the one side of the hologram recording medium, and loading captured image data corresponding to the image data; and
carrying out an inverse Fourier transform process on the loaded captured image data.
